(19) United States
(12) Patent Application Publication
(10) Pub. No.: US 2017/0227809 A1
(43) Pub. Date: Aug. 10, 2017

(54) DISPLAY DEVICE

(71) Applicant: Panasonic Liquid Crystal Display Co., Ltd., Himeji-shi (JP)

(72) Inventors: Takeki SATO, Hyogo (JP); Makoto FUJIMOTO, Hyogo (JP); Ryouhei SHIMANO, Osaka (JP)

(21) Appl. No.: 15/498,053

(22) Filed: Apr. 26, 2017

Related U.S. Application Data
(63) Continuation of application No. PCT/JP2014/005531, filed on Oct. 31, 2014.

(51) Int. Cl. G02F 1/1333; G02F 1/1335

(52) U.S. Cl. CPC G02F 1/133308; G02F 1/133603; G02F 1/133606; G02F 1/133608; G02F 2202/28; G02F 2001/133317

(57) ABSTRACT

A display device includes a display panel, a backlight unit, a double-sided adhesive tape that fixedly bonds the display panel and the backlight unit to each other, and a tab connected to the double-sided adhesive tape. At least a part of the tab protrudes outward from an end portion of the display panel in planar view.

### CROSS-REFERENCE TO RELATED APPLICATION

This application is a bypass continuation of international patent application PCT/JP2014/005531, filed Oct. 31, 2014 designating the United States of America, the entire disclosure of which is incorporated herein by reference.

### TECHNICAL FIELD

The present disclosure relates to a display device, and particularly to a structure of a double-sided adhesive tape bonding a display panel and a backlight unit together.

### BACKGROUND

A display device includes a display panel and a backlight unit disposed on a rear surface side of the display panel. For example, in a bonding process, the display panel and the backlight unit are fixedly bonded together using the double-sided adhesive tape.

In the case where a trouble such as entering of a foreign matter and displacement occurs in the bonding process, the display panel and the backlight unit are peeled off to solve the trouble, and then the bonding process is performed again. It is necessary to securely bond the display panel and the backlight unit together. Therefore, the double-sided adhesive tape has adhesive strength that prevents the display panel and the backlight unit from being easily peeled off. For this reason, the display panel or the backlight unit may be damaged in peeling off the display panel and the backlight unit. For example, a prior art discloses a technique that focuses on this problem (for example, see Japanese unexamined published patent application No. 2008-274163).

The prior art discloses the following configuration. The double-sided adhesive tape has a thermally peelable adhesive layer including thermally expandable microspheres. A heating treatment is performed in peeling off the display panel and the backlight unit. When the thermally peelable adhesive layer is heated, the thermally expandable microspheres expand to reduce an adhesive area with an adherend, thereby lowering the adhesive strength. This enables the display panel and the backlight unit to be peeled off.

However, in the technique of the prior art, the heating may cause deformation of the display panel or backlight unit or may cause a display defect.

### SUMMARY

The present disclosure has been made in view of the above circumstances, and an object thereof is to provide a display device in which a display panel and a backlight unit can be easily peeled off at the time of peel-off without lowering adhesive strength between the display panel and the backlight unit.

In one general aspect, the instant application describes a display device including a display panel, a backlight unit, a double-sided adhesive tape that fixedly bonds the display panel and the backlight unit to each other, and a tab connected to the double-sided adhesive tape. At least a part of the tab protrudes outward from an end portion of the display panel in planar view.

The above general aspect may include one or more of the following features. The backlight unit may include a frame holding the display panel. The frame may include four sidewalls extending in a thickness direction of the display panel and a mounting portion extending horizontally inward from a position below a top surface of each of the sidewalls, the mounting portion on which a peripheral portion of the display panel is mounted, and a notch is formed in at least one of the sidewalls to dispose the tab.

The top surface of the sidewall may include the notch is flush with a top surface of the mounting portion.

The notch may be formed in the sidewall extending in a direction intersecting a direction in which the tab and the double-sided adhesive tape connected to the tab are arranged in a line.

The notch may be formed such that a width of the notch is larger than a width of the tab.

The tab may be connected to an end portion in an extending direction of the double-sided adhesive tape.

The tab may be made of a material identical to a material of the double-sided adhesive tape.

The double-sided adhesive tapes may be individually disposed in correspondence with each of four sides of the display panel. The tab may be connected to one end portion of each of the four double-sided adhesive tapes, and the tab is disposed at each of four corners of the display panel.

The double-sided adhesive tape may have a property in which adhesive strength is lowered when tensile force in a direction parallel to a bonding surface is applied to the double-sided adhesive tape in a state where the display panel and the backlight unit are bonded together.

In the configuration of the display device according to the present disclosure, the display panel and the backlight unit can be easily peeled off at the time of peel-off without lowering the adhesive strength between the display panel and the backlight unit.

### BRIEF DESCRIPTION OF THE DRAWINGS

FIG. 1 is an exploded perspective view schematically illustrating an entire configuration of liquid crystal display device according to an exemplary embodiment;

FIG. 2 is a plan view illustrating an entire configuration of frame;

FIG. 3 is a sectional view taken along line A-A in FIG. 2;

FIG. 4 is a sectional view taken along line B-B in FIG. 2;

FIG. 5 is an enlarged perspective view illustrating a lower left end portion of frame;

FIG. 6 is a plan view illustrating a state in which display panel and backlight unit are fixedly bonded together;

FIGS. 7A to 7C are schematic sectional views for describing a property of double-sided adhesive tape;

FIG. 8 is a plan view illustrating another configuration of a double-sided adhesive tape;

FIG. 9 is a plan view illustrating another configuration of a double-sided adhesive tape;

FIG. 10 is a plan view illustrating another configuration of a double-sided adhesive tape;

FIG. 11 is a plan view illustrating another configuration of a double-sided adhesive tape;

FIG. 12 is a plan view illustrating another configuration of a double-sided adhesive tape;

FIG. 13 is a plan view illustrating another configuration of a double-sided adhesive tape;

FIG. 14 is a plan view illustrating another configuration of a double-sided adhesive tape;

FIG. 15 is a plan view illustrating another configuration of a double-sided adhesive tape;

FIGS. 16A to 16C are perspective views illustrating a configuration of a double-sided adhesive tape;

FIG. 17 is a plan view illustrating another configuration of a double-sided adhesive tape; and

FIGS. 18A and 18B are plan views illustrating another configuration of a double-sided adhesive tape.

### DETAILED DESCRIPTION

In the exemplary embodiment of the present disclosure, a liquid crystal display device is described by way of example. However, a display device according to the present disclosure is not limited to the liquid crystal display device, and may be an organic EL display device and the like.

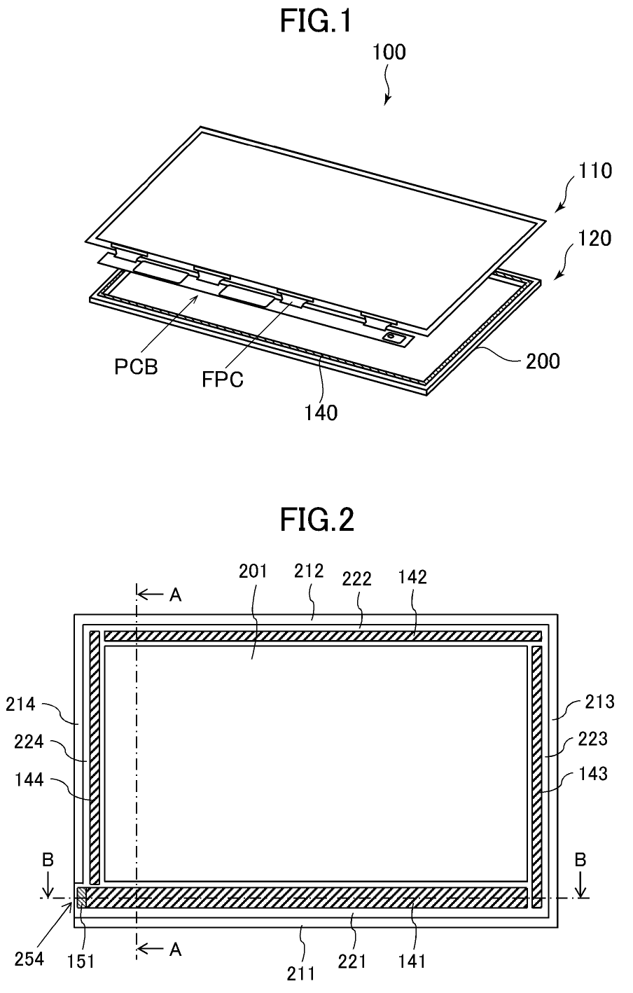

FIG. 1 is an exploded perspective view schematically illustrating an entire configuration of liquid crystal display device 100 according to an exemplary embodiment. Liquid crystal display device 100 mainly includes display panel 110 and backlight unit 120 disposed on a rear surface side of display panel 110. One end of flexible printed circuit FPC is connected to an end portion (for example, a lower end portion) of one side of display panel 110, and printed circuit board PCB is connected to the other end of flexible printed circuits FPC. Backlight unit 120 includes a light source (not illustrated) such as an LED, an optical member (not illustrated) such as a diffusion plate and an optical sheet, and frame 200 that holds display panel 110 while accommodating the optical member. Frame 200 may be configured by a lower frame accommodating the optical member and a hold frame holding display panel 110. Double-sided adhesive tape 140 is disposed between display panel 110 and backlight unit 120 to fixedly bond display panel 110 and backlight unit 120 together. In double-sided adhesive tape 140, one of surfaces (rear surface side) is bonded to an entire peripheral portion (four sides) of frame 200, and the other surface (display surface side) is bonded to an entire peripheral portion (four sides) of display panel 110.

In printed circuit board PCB, flexible printed circuits FPC is folded in a lower end portion of display panel 110, and fixedly bonded to a lower side of a rear surface of backlight unit 120 using the double-sided adhesive tape.

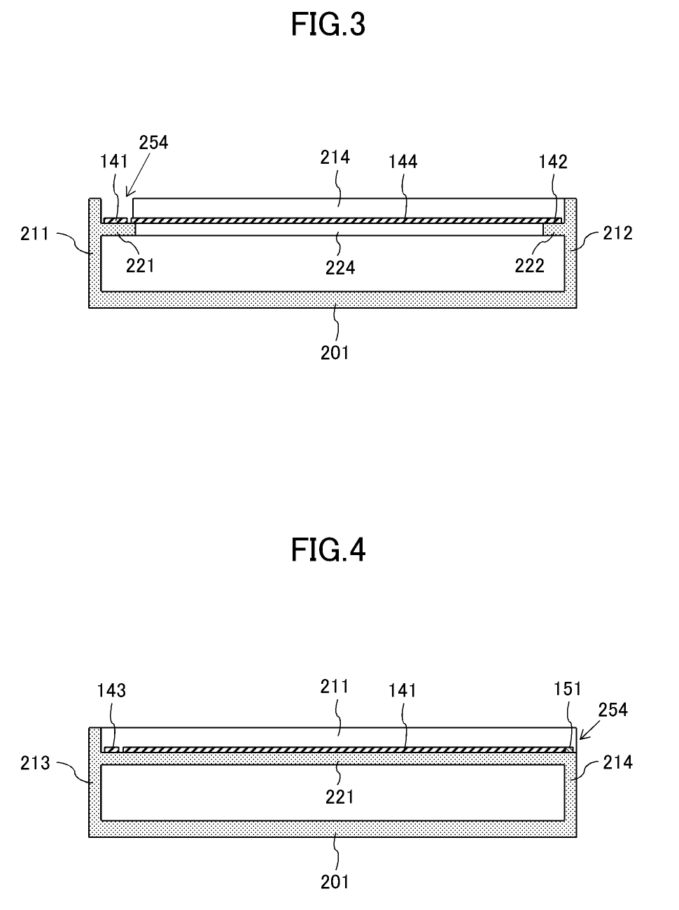

FIG. 2 is a plan view illustrating an entire configuration of frame 200, FIG. 3 is a sectional view taken along line A-A in FIG. 2, and FIG. 4 is a sectional view taken along line B-B in FIG. 2. Double-sided adhesive tape 140 is also illustrated in FIGS. 2 to 4. Frame 200 includes bottom plate 201 on which the light source is disposed, four sidewalls 211 to 214 rising from an outer peripheral end portion of bottom plate 201 toward the display surface side (a thickness direction of the display panel), and mounting portions 221 to 224 that extend inward in a horizontal direction from sidewalls 211 to 214 at positions below the top surfaces of sidewalls 211 to 214 in order to mount display panel 110. The top surfaces of four sidewalls 211 to 214 are flush with one another, and top surfaces of four mounting portions 221 to 224 are flush with one another. In a use state of liquid crystal display device 100, sidewall 211 and mounting portion 221 are positioned on a lower side, sidewall 212 and mounting portion 222 are positioned on an upper side, sidewall 213 and mounting portion 223 are positioned on a right side, and sidewall 214 and mounting portion 224 are positioned on a left side.

Because a lower portion of display panel 110 including a connection portion to flexible printed circuits FPC is mounted on mounting portion 221, a width of the top surface of mounting portion 221 is larger than widths of the top surfaces of mounting portions 222 to 224. Double-sided adhesive tapes 140 are disposed in the top surfaces of mounting portions 221 to 224 in accordance with the width of each mounting portion. Width t1 of double-sided adhesive tape 141 disposed in mounting portion 221 is larger than widths t2 to t4 of double-sided adhesive tapes 142 to 144 disposed in mounting portions 222 to 224 (for example, t1>t2=t3=t4). The top surfaces of mounting portions 221 to 224 may have an identical width. Similarly, double-sided adhesive tapes 141 to 144 may have an identical width.

Notch 254 having a width larger than width t1 of double-sided adhesive tape 141 is formed in at least one of sidewalls 213, 214 extending in a direction intersecting an extending direction of double-sided adhesive tape 141 having the largest width t1 in double-sided adhesive tapes 141 to 144. In this case, by way of example, notch 254 is formed in sidewall 214 (see FIGS. 2 and 3). As illustrated in FIG. 4, the top surface of sidewall 214 including notch 254 is substantially flush with the top surface of each mounting portion. Tab 151 of double-sided adhesive tape 141 is disposed in the top surface of sidewall 214 including notch 254. Thus, notch 254 is formed in sidewall 214 extending in the direction (a vertical direction in FIG. 2) intersecting the direction (a horizontal direction in FIG. 2) in which tab 151 and double-sided adhesive tape 141 connected to tab 151 are arranged in a line. Notch 254 is formed at a position where an extended line of double-sided adhesive tape 141 connected to tab 151 and sidewall 214 intersect each other. The width of tab 151 may be equal to or different from the width of double-sided adhesive tape 141. Tab 151 may be made of a material identical to that of double-sided adhesive tape 141, or connected to an end portion of double-sided adhesive tape 141 made of a material different from that of tab 151.

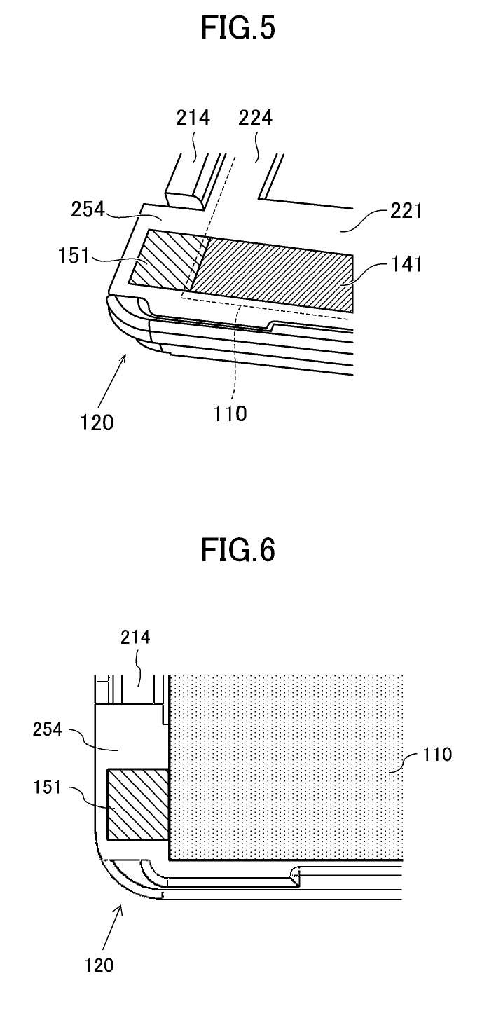

FIG. 5 is an enlarged perspective view illustrating a lower left end portion of frame 200, and FIG. 6 is a plan view illustrating a state in which display panel 110 and backlight unit 120 are fixedly bonded together in the configuration of FIG. 5. As illustrated in FIG. 6, tab 151 is disposed such that at least a part of tab 151 protrudes outward from the end portion of display panel 110 in planar view.

Double-sided adhesive tape 140 has the adhesive strength equivalent to the conventional double-sided adhesive tape, and has a property in which the adhesive strength is lowered when tensile force in a direction (for example, an extending direction of double-sided adhesive tape 140) parallel to an adhesive surface is applied to double-sided adhesive tape 140 in a state where an adherend is bonded. For example, a double-sided tape manufactured by 3M Japan Limited can be used as double-sided adhesive tape 140.

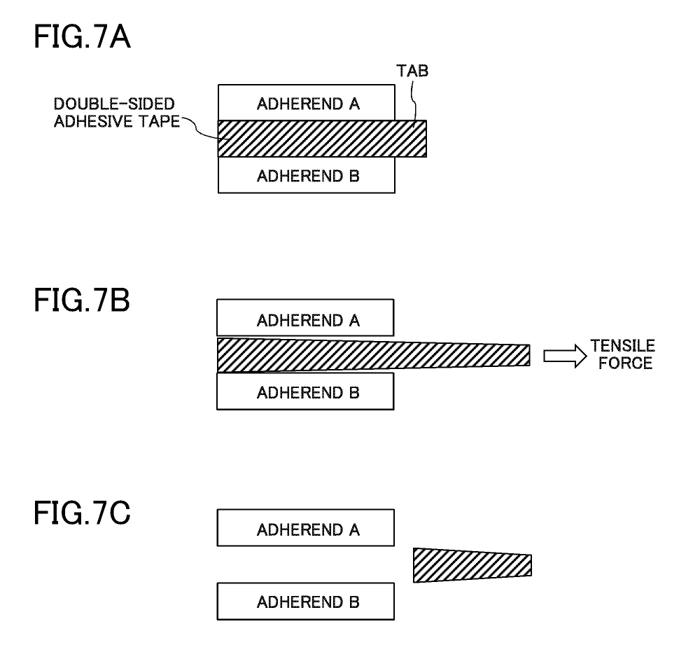

FIGS. 7A to 7C are schematic sectional views for describing a property of double-sided adhesive tape 140. FIG. 7A illustrates a state in which adherend A is bonded to one of surfaces of the double-sided adhesive tape while adherend B is bonded to the other surface. In the state of FIG. 7A, when the end portion (tab) of the double-sided adhesive tape is pulled, the double-sided adhesive tape stretches in a pulling direction to lower the adhesive strength between the double-sided adhesive tape and adherends A, B as illustrated in FIG. 7B. When the end portion of the double-sided adhesive tape is further pulled, the double-sided adhesive tape is peeled off from adherends A, B as illustrated in FIG. 7C. Therefore, adherends A, B can be peeled off from each other.

A process of manufacturing liquid crystal display device 100 will be described below. The process of manufacturing liquid crystal display device 100 includes the bonding process of bonding display panel 110 and backlight unit 120 to each other. In the case where a trouble such as entering of the foreign matter and the displacement occurs in the bonding process, a peel-off process of peeling off display panel 110 and backlight unit 120 from each other is performed to solve the trouble, and then the bonding process is performed again. The peel-off process is also included in the process of manufacturing liquid crystal display device 100. Known processes can be adopted as other processes such as a backlight unit manufacturing process, a display panel manufacturing process, and an inspection process. Specific examples of the bonding process and the peel-off process will be described below.

In the bonding process, surfaces (rear surface sides) of double-sided adhesive tapes 141 to 144 are bonded to top surfaces of mounting portions 221 to 224 of frame 200 in backlight unit 120 manufactured through the backlight unit manufacturing process (see FIG. 2). At this time, double-sided adhesive tape 141 including tab 151 is bonded such that tab 151 is disposed on the top surface of sidewall 214 including notch 254 (in other words, such that tab 151 overlaps notch 254) (see FIG. 5).

Then, display panel 110 manufactured through the display panel manufacturing process is aligned with backlight unit 120, and display panel 110 is mounted on the top surfaces of mounting portions 221 to 224 of frame 200 to which double-sided adhesive tapes 141 to 144 are bonded.

Therefore, display panel 110 and backlight unit 120 are fixedly bonded together. Because double-sided adhesive tape 140 has the adhesive strength equivalent to that of the conventional double-sided adhesive tape, display panel 110 and backlight unit 120 are securely bonded together. In the state in which display panel 110 and backlight unit 120 are fixedly bonded together (bonded state), tab 151 protrudes outward from the end portion of display panel 110 in planar view (see FIG. 6).

The inspection process is performed after the bonding process. At this point, for example, the inspection process includes a lighting inspection process and a position inspection process. In the lighting inspection process, for example, the foreign matter that has entered between display panel 110 and backlight unit 120 can be detected by checking a lighting state of a display region. In the position inspection process, for example, displacement can be detected by checking alignment marks of display panel 110 and backlight unit 120. The peel-off process is performed in the case where the entering of the foreign matter or the displacement is detected in the inspection process.

In the peel-off process, an operator pulls tab 151 of double-sided adhesive tape 141 in the extending direction of double-sided adhesive tape 141 by holding, with a hand or a tool, tab 151 protruding outward from the end portion of display panel 110 (see FIG. 6). Tab 151 is disposed outside display panel 110, and the operator can easily hold tab 151 because the operator can directly recognize tab 151 by sight. The operation to hold and pull tab 151 may be performed with a machine such as a robot. Therefore, as illustrated in FIGS. 7A to 7C, the adhesive strength of double-sided adhesive tape 141 is lowered, and double-sided adhesive tape 141 is peeled off and pulled out from display panel 110 and backlight unit 120.

Because width t1 of double-sided adhesive tape 141 is larger than widths t2 to t4 of double-sided adhesive tapes 142 to 144 on the remaining three sides, the adhesive strength between double-sided adhesive tape 141 and the adherend (display panel 110 and backlight unit 120) becomes the maximum. Therefore, display panel 110 and backlight unit 120 can be easily peeled off by peeling off (pulling out) double-sided adhesive tape 141. For example, using a gap in a lower portion (the side where double-sided adhesive tape 141 is peeled off) of display panel 110, display panel 110 and backlight unit 120 may be peeled off by pulling display panel 110 and backlight unit 120 in a direction (opposite direction) in which display panel 110 and backlight unit 120 are separated from each other in the thickness direction. The operator may peel off display panel 110 and backlight unit 120 by inserting a cutter in the gap of the lower portion of display panel 110 to cut double-sided adhesive tapes 142 to 144 on the remaining three sides. Double-sided adhesive tapes 142 to 144, which remain on display panel 110 and backlight unit 120 after the peel-off of display panel 110 and backlight unit 120, can be easily peeled off by pulling double-sided adhesive tapes 142 to 144 in the extending direction of each of double-sided adhesive tapes 142 to 144. In the above configuration, double-sided adhesive tape 141 of double-sided adhesive tape 140 may have the above property (the property in which the adhesive strength is lowered when the tensile force is applied in the direction parallel to the adhesive surface), and double-sided adhesive tapes 142 to 144 have a different property (for example, a property of the general double-sided adhesive tape).

In this manner, display panel 110 and backlight unit 120 are separated from each other. Then, the bonding process is performed again after the foreign matter is removed or after the alignment is performed. In the rebonding process, peeled double-sided adhesive tapes 141 to 144 may be reused, or new double-sided adhesive tapes 141 to 144 may be used. The peel-off process and the bonding process are repeatedly performed until troubles such as the entering of the foreign matter and the displacement are solved.

In the configuration of liquid crystal display device 100 described above, display panel 110 and backlight unit 120 can be easily peeled off at the time of peel-off without lowering the adhesive strength between display panel 110 and backlight unit 120.

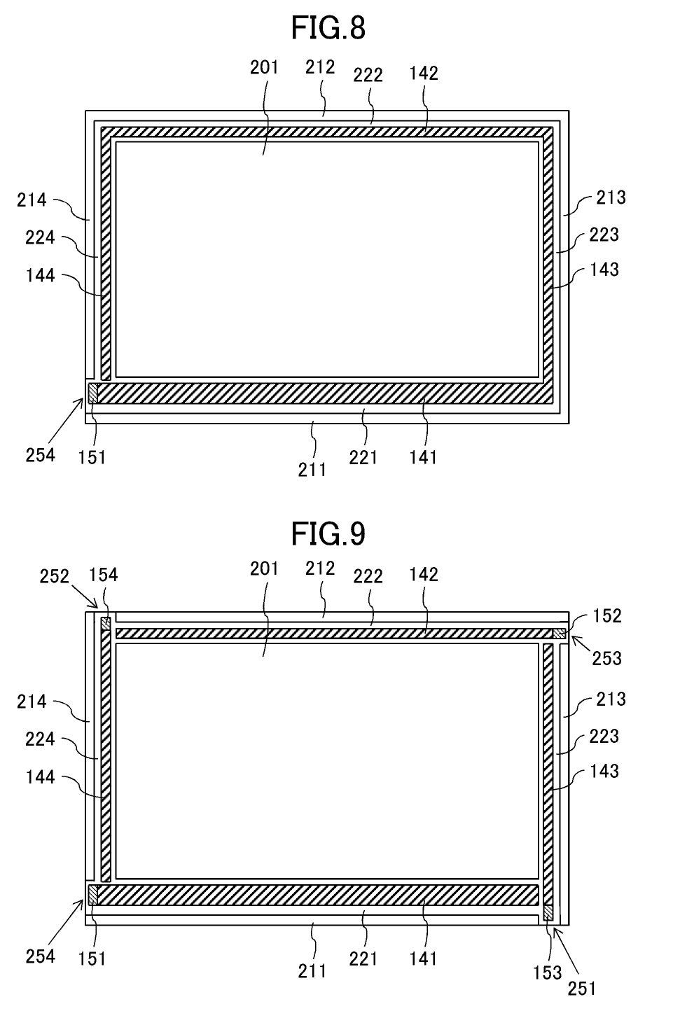

Liquid crystal display device 100 is not limited to the above configuration. For example, double-sided adhesive tapes 141 to 144 may be integrally formed as illustrated in FIG. 8. In the configuration of FIG. 8, all double-sided adhesive tapes 141 to 144 can be peeled off by pulling tab 151 of double-sided adhesive tape 141 in the extending direction of double-sided adhesive tape 141.

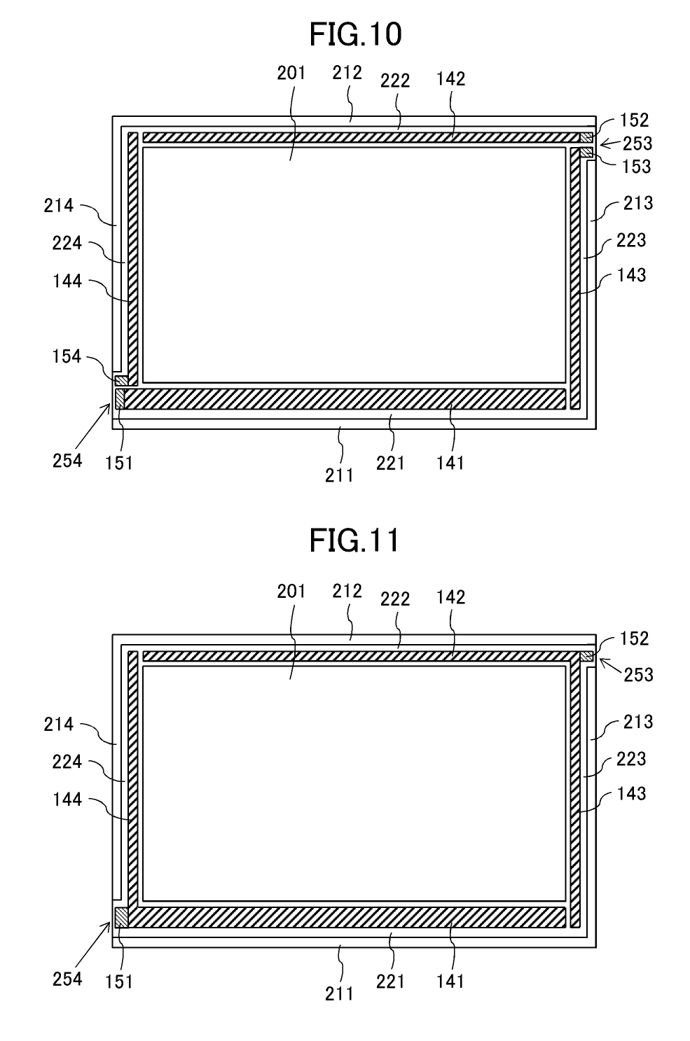

As illustrated in FIG. 9, tabs 151 to 154 may be connected to the end portions of double-sided adhesive tapes 141 to 144, and notches 251 to 254 may be formed in sidewalls 211 to 214. In the configuration of FIG. 9, all double-sided adhesive tapes 141 to 144 can be peeled off by pulling tabs 151 to 154 of double-sided adhesive tapes 141 to 144. In the above configuration, tabs 151 to 154 may be disposed at the four corners of display panel 110 as illustrated in FIG. 9, or tabs 151, 154 may be disposed at one of corners on a diagonal line of display panel 110 while tabs 152, 153 are disposed at the other corner as illustrated in FIG. 10.

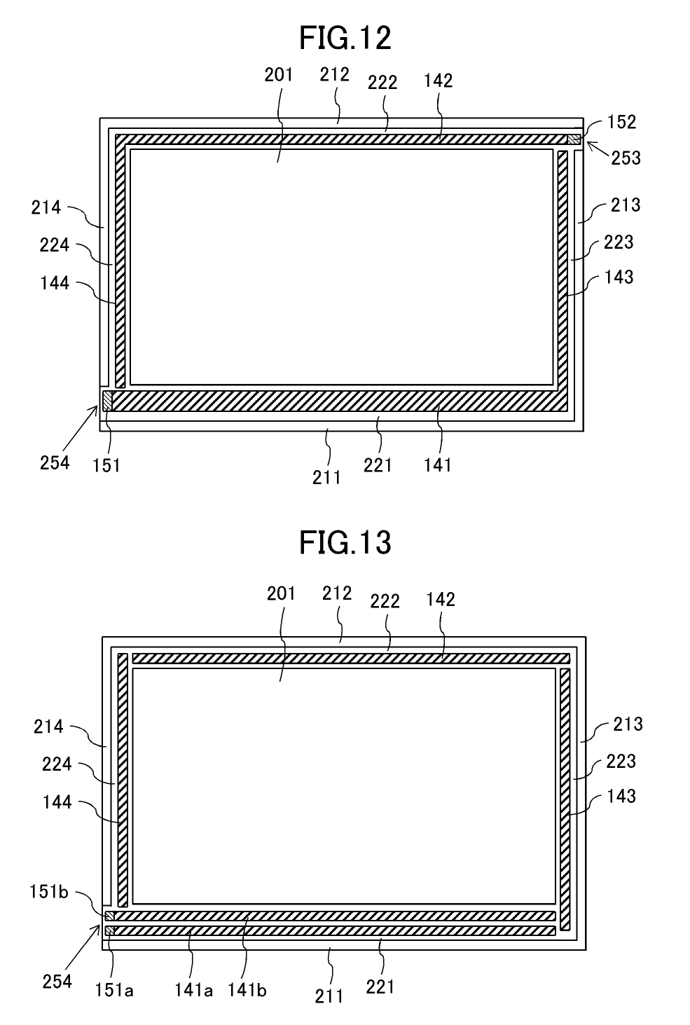

As illustrated in FIG. 11, double-sided adhesive tapes 141, 144 may be integrally formed and connected to tab 151, and double-sided adhesive tapes 142, 143 may be integrally formed and connected to tab 152. As illustrated in FIG. 12, double-sided adhesive tapes 141, 143 may be integrally formed and tab 151 may be connected to the end portion of double-sided adhesive tape 141, and double-sided adhesive tapes 142, 144 may be integrally formed and tab 152 may be connected to the end portion of double-sided adhesive tape 142.

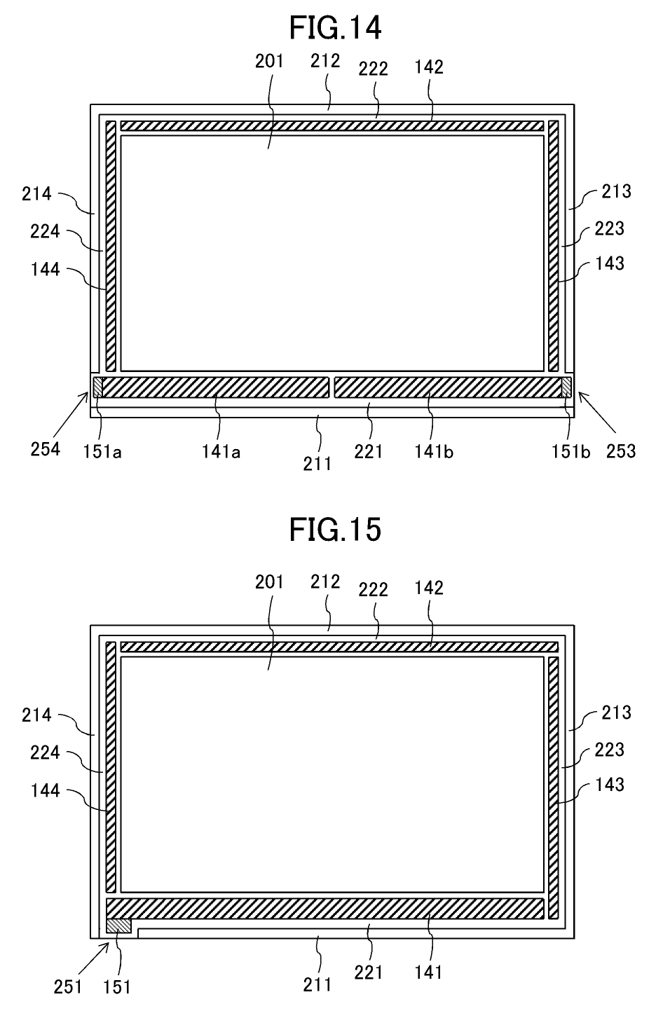

As illustrated in FIG. 13, two double-sided adhesive tapes 141a, 141b, arranged in parallel to each other, may be adhered to mounting portion 221 corresponding to a lower portion of display panel 110. Tabs 151a, 151b are connected to end portions of double-sided adhesive tapes 141a, 141b, respectively. As illustrated in FIG. 14, two double-sided adhesive tapes 141a, 141b, arranged horizontally to each other, may be adhered to mounting portion 221 corresponding to the lower portion of display panel 110. In the configurations of FIGS. 13 and 14, the adhesive strength per one double-sided adhesive tape is lowered as compared to the configuration in FIG. 2, so that the double-sided adhesive tape can be easily peeled off.

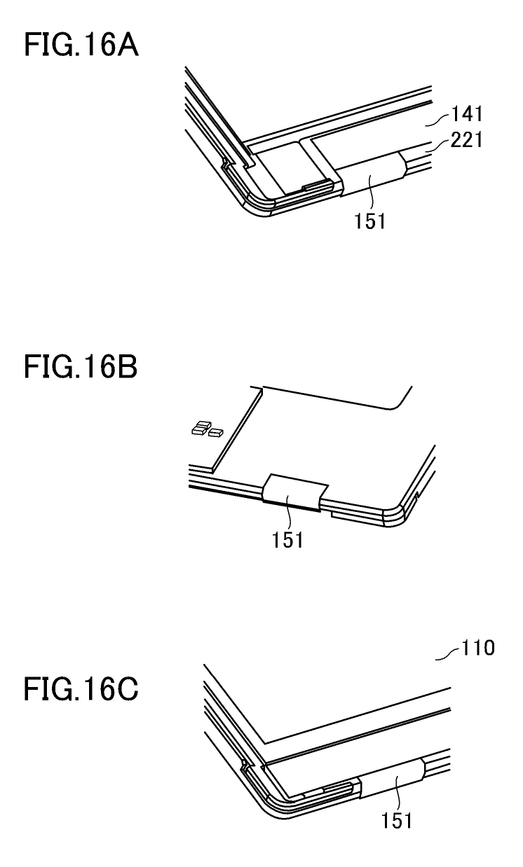

The position to which the tab is connected to the double-sided adhesive tape is not limited to the above configurations. For example, as illustrated in FIG. 15, tab 151 may be connected to the lateral surface in the end portion of double-sided adhesive tape 141. In the configuration of FIG. 15, notch 251 is formed in sidewall 211. As illustrated in FIGS. 16A and 16B, tab 151 may be extended to a rear surface (backside) of backlight unit 120 and fixed. FIG. 16B illustrates the rear surface side of backlight unit 120, and FIG. 16C illustrates a state in which display panel 110 is mounted.

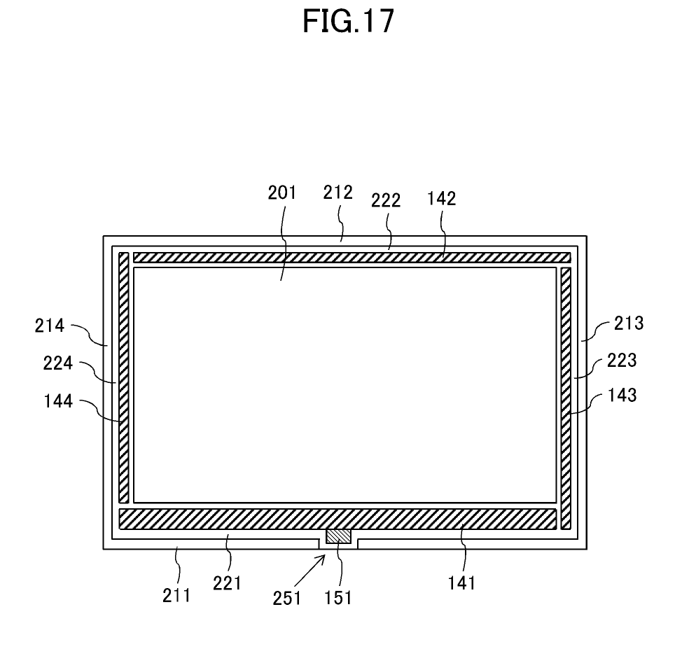

As illustrated in FIG. 17, tab 151 may be connected to a lateral surface near a center of double-sided adhesive tape 141. In the configuration of FIG. 17, notch 251 is formed near the center of sidewall 211.

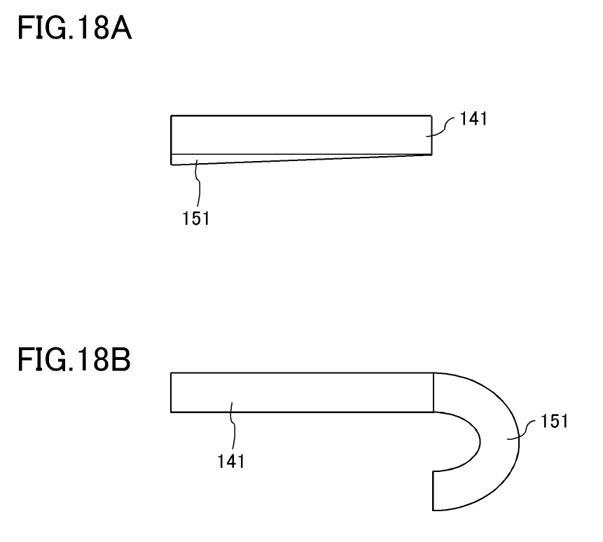

The shape of the tab is not limited to the above configurations. For example, as illustrated in FIG. 18A, tab 151 may have a shape in which a base spreads toward the extending direction of double-sided adhesive tape 141. As illustrated in FIG. 18B, tab 151 may have an arc shape.

Although exemplary embodiments of the present disclosure are described above, the present disclosure is not limited to these exemplary embodiments. It is noted that exemplary embodiments properly changed from the exemplary embodiments described above by those skilled in the art without departing from the scope of the present disclosure are included in the present disclosure.

What is claimed is:

1. A display device comprising:
a display panel;
a backlight unit;
a double-sided adhesive tape that fixedly bonds the display panel and the backlight unit to each other; and
a tab connected to the double-sided adhesive tape,
wherein at least a part of the tab protrudes outward from an end portion of the display panel in planar view.

2. The display device according to claim 1, wherein
the backlight unit includes a frame holding the display panel,
the frame includes four sidewalls extending in a thickness direction of the display panel and a mounting portion extending horizontally inward from a position below a top surface of each of the sidewalls, the mounting portion on which a peripheral portion of the display panel is mounted, and
a notch is formed in at least one of the sidewalls to dispose the tab.

3. The display device according to claim 2, wherein the top surface of the sidewall including the notch is flush with a top surface of the mounting portion.

4. The display device according to claim 2, wherein the notch is formed in the sidewall extending in a direction intersecting a direction in which the tab and the double-sided adhesive tape connected to the tab are arranged in a line.

5. The display device according to claim 2, wherein the notch is formed such that a width of the notch is larger than a width of the tab.

6. The display device according to claim 1, wherein the tab is connected to an end portion in an extending direction of the double-sided adhesive tape.

7. The display device according to claim 1, wherein the tab is made of a material identical to a material of the double-sided adhesive tape.

8. The display device according to claim 1, wherein the double-sided adhesive tapes are individually disposed in correspondence with each of four sides of the display panel,
the tab is connected to one end portion of each of the four double-sided adhesive tapes, and
the tab is disposed at each of four corners of the display panel.

9. The display device according to claim 1, wherein the double-sided adhesive tape has a property in which adhesive strength is lowered when tensile force in a direction parallel to a bonding surface is applied to the double-sided adhesive tape in a state where the display panel and the backlight unit are bonded together.
